(19) United States
(12) Patent Application Publication
(10) Pub. No.: US 2012/0223205 A1
(43) Pub. Date: Sep. 6, 2012

(54) LOCKING MECHANISM FOR PORTABLE DEVICE CRADLE

(75) Inventor: David Panik, West Bloomfield, MI (US)

(73) Assignee: Perceptron, Inc., Plymouth, MI (US)

(21) Appl. No.: 13/038,715

(22) Filed: Mar. 2, 2011

(51) Int. Cl. F16M 13/02; B23P 11/00

(52) U.S. Cl. 248/316.4; 29/428

(57) ABSTRACT

A cradle assembly for a portable device is provided. The portable device may have details for engaging the cradle assembly. The cradle assembly may include a cradle body and a locking mechanism. The cradle body may support the portable device, while the locking mechanism may be configured to trap the details between the locking mechanism and the cradle body.

### BACKGROUND

### Field of the Invention

The present application is generally related to a cradle assembly with a locking mechanism.

### SUMMARY

A cradle assembly for a portable device is provided. The portable device may have details for engaging the cradle assembly. The cradle assembly may include a cradle body and a locking mechanism. The cradle body may support the portable device, while the locking mechanism may be configured to trap the details between the locking mechanism and the cradle body.

According to other aspects of the disclosure the assembly may also include a spring biasing the locking mechanism to form an interference with a detail of the portable device by pushing a recess in each of the details against an edge of each corresponding opening. In addition, the assembly may include locking fingers on the locking mechanism that extend through corresponding slots in the cradle body, the locking fingers being configured to translate along the slots.

According to other aspects of the disclosure the assembly may also include a first detail in the cradle body with a circular recess configured to receive a first end of the spring and a second detail in the locking mechanism with a circular recess configured to receive a second end of the spring. Further, the spring may be contained between the first detail and the second detail in a compressed state.

According to other aspects of the disclosure the locking mechanism may be movable relative to the cradle body between a first position where a recess in the locking mechanism is aligned with an opening in the cradle body to allow a detail of the portable device to extend through the opening and a second position where the locking mechanism locks the detail between the locking mechanism and the cradle body.

According to other aspects of the disclosure the assembly may also include a tab on the locking mechanism configured to engage one detail of the details and force the detail against an edge of the a corresponding opening. Further, the assembly may also include a pre-set surface within a recess on the cradle body.

Further objects, features and advantages of this application will become readily apparent to persons skilled in the art after a review of the following description, with reference to the drawings and claims that are appended to and form a part of this specification. It should be understood that the description and specific examples are intended for purposes of illustration only and are not intended to limit the scope of the present disclosure.

### BRIEF DESCRIPTION OF THE DRAWINGS

Example embodiments of the invention are reflected in the drawings and will be described below. The drawings described herein are for illustration purposes only and are not intended to limit the scope of the present disclosure in any way. The drawings show:

FIG. 1 is a perspective view of a cradle with locking mechanism;

FIG. 2 is an exploded view of the cradle and locking mechanism;

FIG. 3 is a partially assembled perspective view of the cradle and locking mechanism;

FIG. 4 is a perspective view of the other side of the cradle and locking mechanism;

FIG. 5 is a side view a magnetic foot for use with the cradle;

FIG. 6 is a perspective view illustrating the insertion of the feet into the cradle; and

FIG. 7 is a perspective view of the feet being locked in the cradle by the locking mechanism.

### DETAILED DESCRIPTION

The following description is merely exemplary in nature and is not intended to limit the present disclosure, application, or uses.

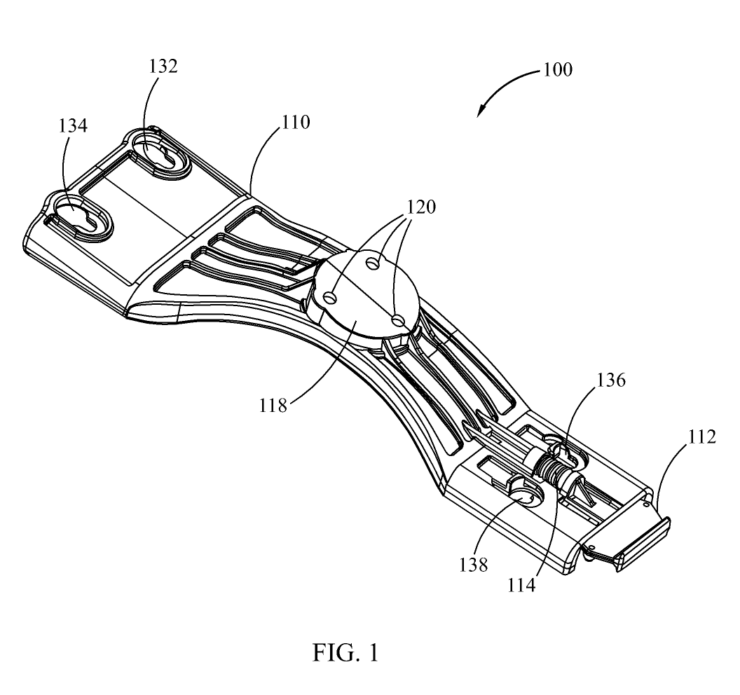

Now referring to FIG. 1, a cradle assembly 100 is provided. The cradle assembly may be provided for seating a portable device, such as a portable processing or display unit. The cradle assembly 100 includes a cradle body 110, a locking mechanism 112 and a spring 114. The cradle body 110 may include a mounting surface 118 and mounting holes 120 for mounting the cradle on various other devices. The cradle body 110 includes openings 132, 134, 136, 138 for receiving details, for example feet, of the portable processing or display device. Further, the locking mechanism 112 may capture the details (e.g. feet) against the cradle body thereby locking the portable processing or display device in position and orientation relative to the cradle assembly 100. In one example, the locking mechanism 112 may operate in coordination with the spring 114 to bias the locking mechanism 112 such that the details are forced against the cradle body while partially extending through the openings 132, 134, 136, 138.

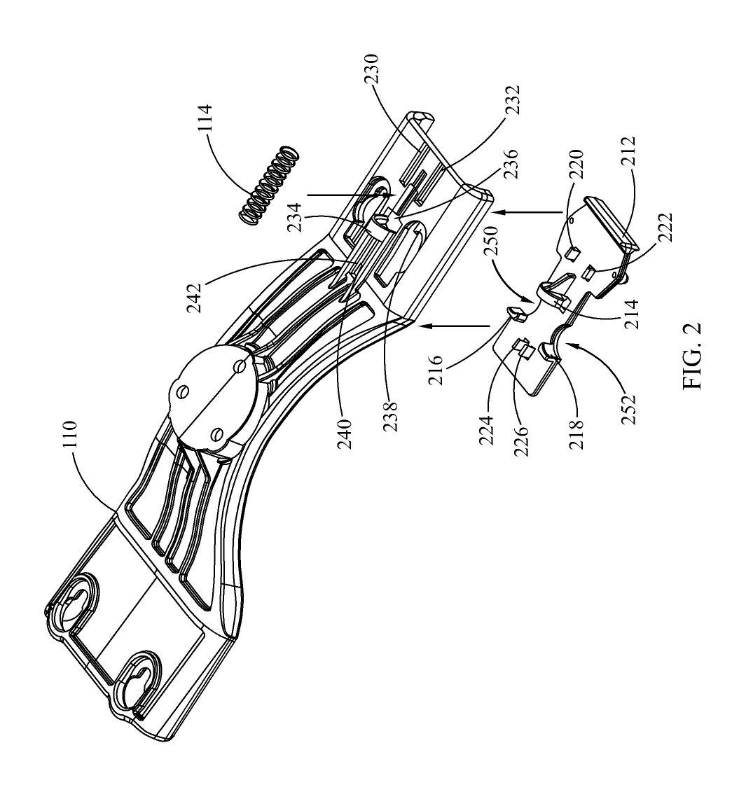

Now referring to FIG. 2, an exploded view of the cradle assembly 100 is provided. The locking mechanism 112 may include a lip 212 that may serve as a handle for the user to push or pull the locking mechanism with respect to the cradle body 110. The locking mechanism 112 may include locking fingers 220, 222, 224, and 226. The locking fingers 220, 222, 224, and 226 may extend through corresponding slots 230, 232, 242, 240 in the cradle body 110. For example, locking finger 220 may extend through slot 230 such that the locking finger 220 deflects while traveling through the slot 230 and then prevents removal of the finger 220 from the slot 230 without the finger 220 again being deflected. Further, the locking finger 220 may slide along the slot 230, thereby allowing the locking mechanism 212 to slide linearly with respect to the cradle body 110. Similarly, locking finger 222 may lock into slot 232 thereby holding the locking mechanism in position relative to the cradle body 110, yet allowing linear translation of the locking mechanism 112 with respect to the cradle body 110. In the same manner, locking finger 224 extends through and locks into slot 242, while locking finger 226 extends through and locks into slot 240.

In addition, a semi-circular feature 214 of the locking mechanism 112 includes a circular recess and a lip that receives and houses one side of the spring 114. Further, a circular feature 234 has a circular recess and a lip to receive and house the other end of the spring 114. As such, features 234 and 214 fix the position of the spring 114 with respect to the cradle 110 and the locking mechanism 112. Since the spring 114 is compressed and each end of the spring is housed in the respective feature 234 and 214, the spring 114 is captured between the features 234, 214. Since the spring 114 is compressed, the spring 114 biases the locking mechanism 112 away from the cradle body 110 such that the locking fingers 220, 222, 224, 226 are biased to one end of the respective slots 230, 232, 242, 240. In addition, the locking mechanism 112 includes recesses 250 and 252 that align with openings 136 and 138 of the cradle body 110, respectively. Further, it is noted that the circular detail 214 extends through the opening 236 in the cradle body 110 to align with detail 234 of the cradle 110. In addition, the opening 236 may allow the detail 214 to slide linearly with respect to the cradle body 110 thereby allowing the locking mechanism 112 to move with respect to the cradle body 110 between the first and second positions.

Accordingly, the recesses 250 and 252 may cooperate with edges in the openings 136, 138 such that when the locking mechanism 112 is in a first position, the details (e.g. feet) may be allowed to extend through the openings 136, 138. However, in a second position of the locking mechanism 112, the edges 138, 139 of the openings 136, 138 will cooperate with the locking mechanism 112 to cause an interference fit with the details (e.g. feet) of the portable processing device. Further, the locking mechanism 112 includes tabs 216 and 218 on one end of the recesses 250, 252, respectively, to push against the details (e.g. feet) of the portable processing device that is to be locked in place by the cradle.

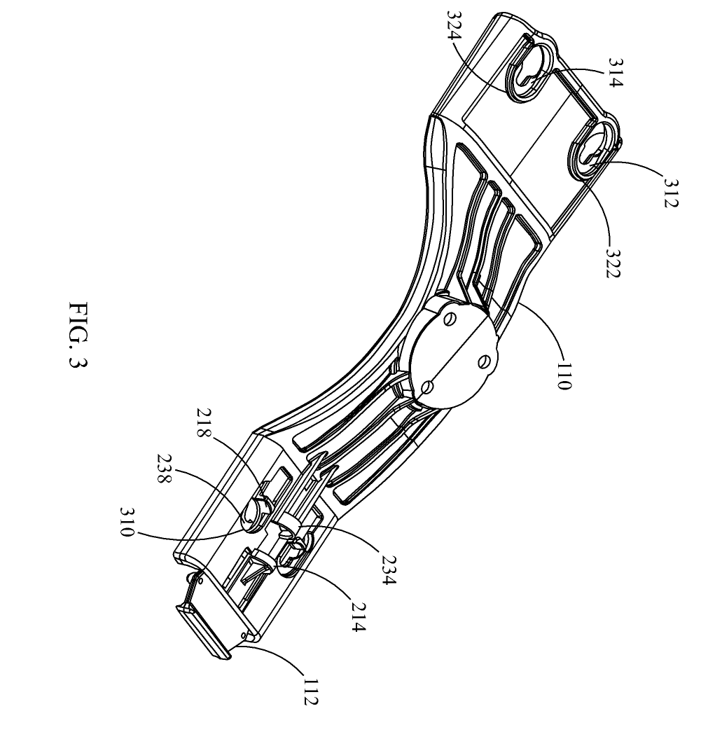

Now referring to FIG. 3, a partially assembled view of the cradle assembly is provided. In this view, the locking mechanism 112 has been inserted into the cradle body 110 such that the locking fingers 220, 222, 224, 226 are in position and the circular feature 214 extends through the cradle body 110 in alignment with circular feature 234 to receive the compressed spring 114. Further, the workings of the tab 218 can more clearly be seen with respect to the edge 238 of opening 138. Accordingly, the tab 218 may press against a detail (e.g. foot) thereby sliding it against the edge 238 causing an interference foot with the detail (e.g. foot) and locking it in position with respect to the cradle body 110. Further, the opening 138 may include a recess 310 with respect to the edge to better secure the detail (e.g. foot) in place with respect to the cradle body 110. Note that both the tab 218 and the edge 238 may be formed to match a surface of the detail (e.g. foot) For example, the foot may have a recess and in the locked position the tab 218, the edge 238, or both may have a curved surface with a radius to match a radius of the foot. This may also apply to tab 216 and edges of any of the openings 132, 134, 136, 138.

Similarly, each opening may include a recess and edge as is illustrated by recesses 322, 324 and edges 312 and 314. Further, while tabs 216, 218 cooperate with edges of openings 136, 138, respectively, to form an interference fit and thereby locking the position of the details (e.g. feet) of the portable device. The edges 312 and 314 may serve to lock the position of the device without the aid of corresponding tabs. Since the device and position of the feet may be rigid, the tabs 216, 218 may also serve to push the detail (e.g. foot) against their respective edges 312 and 314 through the rigid body of the device.

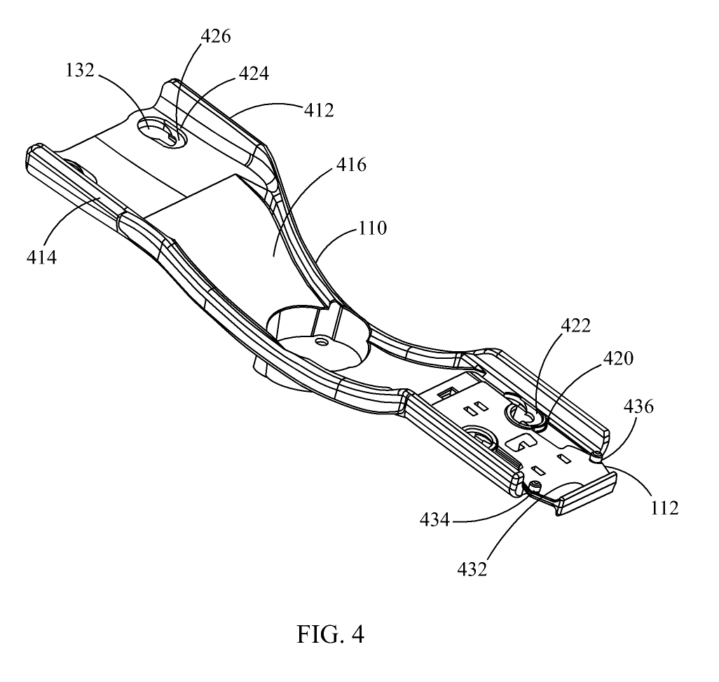

Now referring to FIG. 4 the front side of the cradle assembly is illustrated. The cradle body 110 includes a recess 416 formed by side portions 412 and 414. As such, the portable processing device may be received within the recess 416. The openings 132, 134, 136, 138 may include recesses (shown in FIGS. 4 as 420 and 424) that lead to a preset surface shown as reference numeral 426 for opening 132 and reference numeral 422 for opening 136. Further, the details (e.g. feet) of the portable processing device may be placed on the preset surfaces (e.g., 426, 422 of recesses 420, 424). As such, when the locking mechanism 112 is moved forward, the portable processing or display device may also be moved forward such that the details (e.g. feet) are moved forward within the recess and fall through the opening.

The locking mechanism 112 may include protrusions such as protrusion 434 and 436 that may extend into a recess or screw hole in the housing of the portable device and, therefore, push the portable device forward as the locking mechanism 112 is moved forward. Additionally, the locking device 112 may have a lip or flange, as denoted by reference numeral 432, which may also aid in pushing the portable device forward and thereby guiding the details (e.g. feet) forward and through the openings in the cradle body 110.

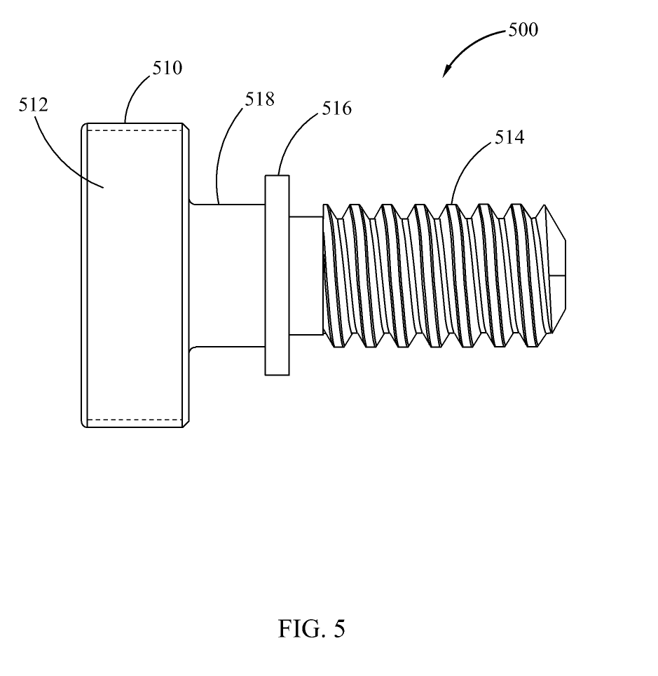

Now referring to FIG. 5, one example of a detail of the portable device is shown as a magnetic foot. The magnetic foot 500 includes a head 510 which houses a magnetic insert 512. Opposite the head 510 is a threaded portion 514 that may be used to attach the magnetic foot onto the housing of the portable device. Further, a flange 516 is provided between the head 510 and the threaded portion 514. As such, a recess is formed between the flange 516 and the head 510 such that an edge of the cradle body 110 and an edge of the locking mechanism 112 may form an interference fit with the magnetic foot 500 in the recess 518. Accordingly, the edge of the cradle body 110 and the locking mechanism 112 lock the magnetic foot in place thereby fixing the position of the portable device relative to the cradle assembly 100.

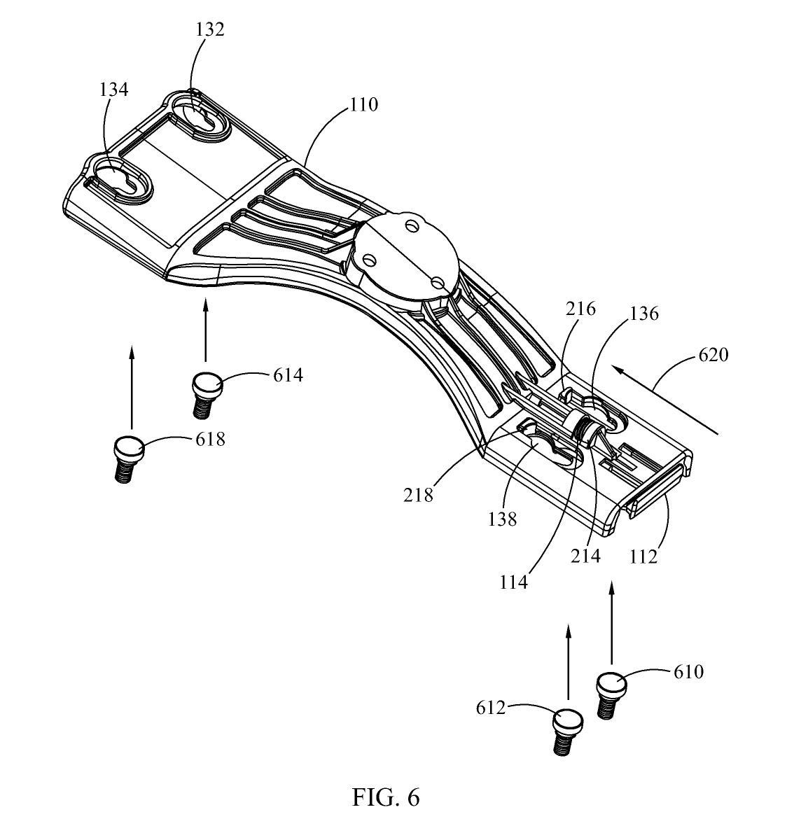

Now referring to FIG. 6, a plurality of feet 610, 612, 614, 618 of the portable device are shown as they would be received by the cradle assembly 100. For the cradle assembly to be able to receive the feet, the locking mechanism 100 may need be pushed forward into the first position, as denoted by arrow 620 thereby compressing spring 114. Accordingly, tabs 216 and 218 move forward aligning the recesses 250 and 252 with openings 136 and 138, respectively. This increases the size of the openings allowing the heads of each of the feet 610, 612, 614, 618 to extend through the respective openings 136, 138, 132, 134.

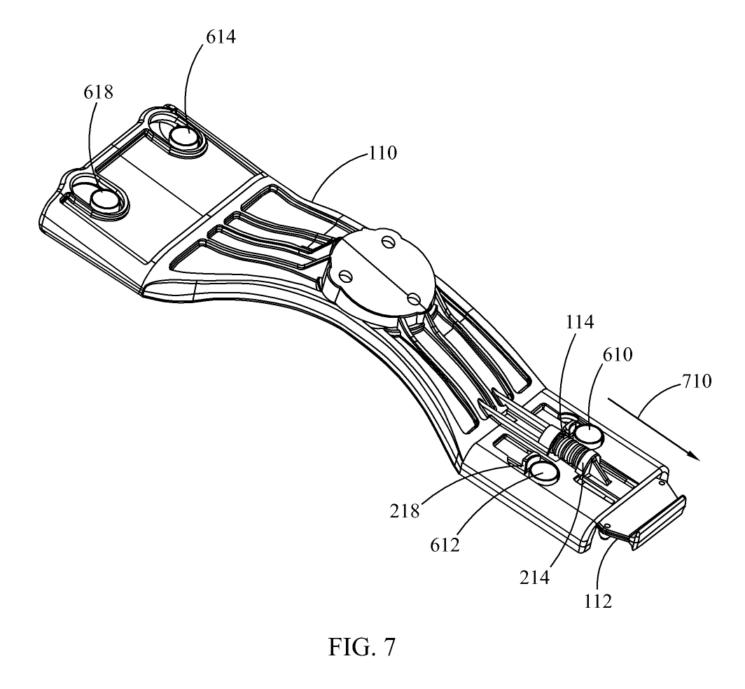

Now referring to FIG. 7 as the locking mechanism 112 is released, the spring 114 biases the locking mechanism to move linearly backwards into the second position until the locking mechanism 112 captures the feet 610, 612, 614, 618 against the cradle body 110 or the locking fingers 220, 222, 224, 226 reach the end of their respective slots 230, 232, 242, 240. As such, the tabs 216, 218 push the feet 610, 612 against the edge of the openings 136, 138 thereby trapping the feet 610, 612 between the locking mechanism 112 and the cradle body 110 with the force generated by the spring 114. In addition, if the housing of the portable device is a rigid housing, the feet 614, 618 will also be pulled forward against the edges of openings 134, 132 which are narrowed and, therefore, will slide into the recesses of the feet 614, 618 and trap the feet 614, 618, as described above with respect to FIG. 5.

For removing the portable device from the cradle body 110, the locking mechanism 112 may be moved forward again to the first position where the recesses 150 and 152 are aligned with openings 136 and 138. The portable device may then be pulled away from the cradle body 110, thereby removing the details (e.g. feet) from the openings and allowing free movement of the portable device.

As a person skilled in the art will readily appreciate, the above description is meant as one illustration of the principles of the invention. This description is not intended to limit the scope or application of the invention in that the invention is susceptible to modification, variation and change, without departing from spirit of the invention, as defined in the following claims.

I claim:

1. A cradle assembly for a portable device having details for engaging the cradle assembly, the cradle assembly comprising:
a cradle body for supporting the portable device;
a locking mechanism trapping the details between the locking mechanism and the cradle body.

2. The cradle assembly according to claim 1, further comprising a spring biasing the locking mechanism to form an interference with a detail of the portable device by pushing a recess in each of the details against an edge of each corresponding opening.

3. The cradle assembly according to claim 1, further comprising locking fingers on the locking mechanism that extend through corresponding slots in the cradle body, the locking fingers being configured to translate along the slots.

4. The cradle assembly according to claim 1, further comprising a first detail in the cradle body with a circular recess configured to receive a first end of the spring.

5. The cradle assembly according to claim 1, further comprising a second detail in the locking mechanism with a circular recess configured to receive a second end of the spring.

6. The cradle assembly according to claim 1, wherein the spring is contained between the first detail and the second detail in a compressed state.

7. The cradle assembly according to claim 1, wherein the locking mechanism is movable relative to the cradle body between a first position where a recess in the locking mechanism is aligned with an opening in the cradle body to allow a detail of the portable device to extend through the opening and a second position where the locking mechanism locks the detail between the locking mechanism and the cradle body.

8. The cradle assembly according to claim 1, further comprising a tab on the locking mechanism configured to engage one detail of the details and force the detail against an edge of the a corresponding opening.

9. The cradle assembly according to claim 1, further comprising a pre-set surface within a recess on the cradle body.

10. A cradle assembly for a portable device having feet for engaging the cradle assembly, the cradle assembly comprising:
a cradle body for supporting the portable device, the feet of the portable device extending through corresponding openings in the cradle assembly;
a locking mechanism engaging the cradle body; and
a spring biasing the locking mechanism to form an interference with the feet of the portable device by pushing a recess in each of the feet against an edge of each corresponding opening.

11. The cradle assembly according to claim 10, further comprising locking fingers on the locking mechanism that extend through corresponding slots in the cradle body, the locking fingers being configured to translate along the slots.

12. The cradle assembly according to claim 10, further comprising a first detail in the cradle body with a circular recess configured to receive a first end of the spring.

13. The cradle assembly according to claim 10, further comprising a second detail in the locking mechanism with a circular recess configured to receive a second end of the spring.

14. The cradle assembly according to claim 10, wherein the spring is contained between the first detail and the second detail in a compressed state.

15. The cradle assembly according to claim 10, wherein the locking mechanism is movable relative to the cradle body between a first position where a recess in the locking mechanism is aligned with an opening in the cradle body to allow a foot of the portable device to extend through the opening and a second position where the locking mechanism locks the foot between the locking mechanism and the cradle body.

16. The cradle assembly according to claim 10, further comprising a tab on the locking mechanism configured to engage one foot of the feet and force the foot against an edge of the a corresponding opening.

17. The cradle assembly according to claim 10, further comprising a pre-set surface within a recess on the cradle body.

18. A method for engaging a portable device in a cradle assembly, the method comprising:
extending feet of the portable device through corresponding openings in the cradle assembly;
engaging the feet of the portable device with a locking mechanism; and
biasing the locking mechanism to form an interference with the feet of the portable device by pushing a recess in each of the feet against an edge of each corresponding opening.

19. The method of claim 18, further comprising moving the locking mechanism relative to the cradle body between a first position and a second position, where in the first position a recess in the locking mechanism is aligned with an opening in the cradle body to allow a foot of the portable device to extend through the opening and a second position where the locking mechanism locks the foot between the locking mechanism and the cradle body.

20. The method according to claim 19, further comprising extending locking fingers on the locking mechanism through corresponding slots in the cradle body and translating the locking fingers along the slots as the locking mechanism moves from the first position to the second position.
